(19) United States
(12) Patent Application Publication
(10) Pub. No.: US 2010/0263450 A1
(43) Pub. Date: Oct. 21, 2010

(54) SYSTEM AND METHOD FOR PRODUCING AND TESTING METAL PARTS

(76) Inventor: Richard S. Bobrek, Simpsonville, SC (US)

Correspondence Address: NIXON & VANDERHYE P.C., 901 NORTH GLEBE ROAD, 11TH FLOOR, ARLINGTON, VA, 22203, US

(21) Appl. No.: 12/424,578

(22) Filed: Apr. 16, 2009

(51) Int. Cl. G01N 29/04; B22F 3/14; B22F 3/24

(52) U.S. Cl. 73/622; 419/48; 419/28

(57) ABSTRACT

A cylindrical metal part is formed by filling a metallic jacket with a powdered metal material and subjecting the metallic jacket to heat and pressure to cause the powdered metal material to form a unitary metal part. The small grain size of the metal material forming the unitary metal part will then allow for ultrasonic testing to be performed to detect voids and imperfections having very small dimensions. The ultrasonic testing can be performed through the metallic jacket, or after the metallic jacket has been removed from the unitary metal part. Additional forging steps may be performed to form shaped protrusions on the exterior of the metal part.

### BACKGROUND OF THE INVENTION

Large metal cylindrical parts which are used in various rotating machinery must be inspected after they are produced to ensure that there are no imperfections or voids present in the metallic material. This is particularly important when the rotating metal part will be used in a machine that rotates at high speeds, and/or in machinery which require a high degree of reliability. For instance, the rotating shafts of turbine engines used in power plants and in aircraft engines are subjected to extremely high rotational speeds. It is very important that those cylindrical rotating parts never fail due to a void or imperfection located within the metal.

In background art methods of forming such metallic parts, a metal material is first melted and then poured into a mold. The metal is cooled to form a solid cylindrical metal part. The metal part could then be subject to testing and inspection to ensure that no voids or imperfections were formed inside the material of the part during the formation steps.

Unfortunately, when metal material is melted and then poured into a mold as described above, the resulting grain size makes it difficult or impossible to conduct ultrasonic testing on the resulting part to determine if very small voids or imperfections are present in the material. The large grain size of the metallic material prevents ultrasonic testing from identifying extremely small voids or imperfections.

In addition, after a metallic part has been formed, it is very common to conduct forging and machining steps to arrive at the final form of the part. The forging steps are used to create a rectilinear shaped object so that the exterior surfaces of the object are flat. This is necessary because the ultrasonic testing techniques require that a transducer of the ultrasonic testing device be placed into contact with flat exterior surfaces of the object.

After the forged object that been tested, machining steps are performed arrive at the final desired shape. Because the machining steps only remove metal, there is no need for inspecting the part after the machining steps are performed.

Because the ultrasonic testing of the forged part require flat surfaces, the forging steps can only produce a rectilinear shaped object. Typically, this means that a significant amount of the metal of the forged and tested part must be removed to then arrive at the final shape for the object. The machining steps cost time and money. Also, if a significant amount of the material must be removed after forging, there can be a significant amount of waste. All of these steps increase the cost and time required to produce the part.

### BRIEF DESCRIPTION OF THE INVENTION

In one aspect, the invention involves a method of forming and inspecting a metal part that includes the steps of selecting a metallic jacket having sidewalls, filling the metallic jacket with a powdered metal material, applying heat and pressure to walls of the metallic jacket to cause the powdered metal material to form a unitary metal part, and inspecting the unitary metal part with an ultrasonic sensor through the walls of the metallic jacket.

In another aspect, the invention involves a method of forming and inspecting a metal part that includes the steps of selecting a substantially cylindrical metallic jacket having sidewalls and first and second ends, filling the metallic jacket with a powdered metal material, and applying heat and pressure to the metallic jacket to cause the powdered metal material to form a generally cylindrical unitary metal part. The method can also include the step of inspecting the unitary metal part with an ultrasonic sensor to determine whether there are voids or imperfections in the material of the unitary metal part. The method can further include the steps of forging the unitary metal part to form a forged metal part having angled or curved exterior surfaces, and inspecting the forged metal part using an immersion ultrasonic testing technique.

In another aspect, the invention involves a method of forming and inspecting a metal part that includes the steps of forming a generally cylindrical metal part, inspecting the cylindrical metal part via immersion ultrasonic testing to determine whether there are voids or imperfections in the material of the cylindrical metal part, forging the cylindrical metal part to form a forged metal part having angled or curved exterior surfaces, machining the forged metal part to remove portions of the metal of the forged metal part to produce an inspectable metal part, and inspecting the inspectable metal part via immersion ultrasonic testing to determine whether there are voids or imperfections in the material of the inspectable metal part.

### BRIEF DESCRIPTION OF THE DRAWINGS

FIGS. 1A-1C illustrate a cylindrical metallic jacket which can be used to form a unitary cylindrical part;

FIGS. 2A-2B illustrate steps of a method of applying heat and pressure to a cylindrical metallic jacket;

FIGS. 3A and 3B illustrate steps of applying heat and pressure to an alternately shaped metallic jacket;

FIGS. 4A and 4B illustrate steps of a method of conducting ultrasonic testing on a cylindrical metal part located inside a metal jacket;

FIG. 5 illustrates steps of a method of conducting ultrasonic testing on a cylindrical metal part;

FIG. 6 illustrates the path of movement of an ultrasonic sensor during an inspection process;

FIG. 7 illustrates an example of a final form for a metal part;

FIG. 8A illustrates a shape of a cylindrical metal part that has been tested and is ready to be formed into a final shape;

FIG. 8B illustrates a shape of the cylindrical metal part of FIG. 8A after forging steps of a prior art method have been performed;

FIG. 9A illustrates a shape of a cylindrical metal part after forging steps of a method embodying the invention have been performed; and

FIG. 9B illustrates a shape of a metal part after the forged metal part in FIG. 9A has been subjected to some initial machining steps.

### DETAILED DESCRIPTION OF PREFERRED EMBODIMENTS

As explained above, in background art methods of forming rotating cylindrical parts, the metal used to form the part is first melted and is then poured into a mold. After cooling, the grain size of the resulting metal part is large enough that the grains make it impossible to detect extremely small voids or imperfections in the metal part.

To avoid the problems of the background art, and to allow for ultrasonic testing for very small voids and imperfections, a different method of forming the metal part is performed. Instead of melting a metal material and pouring it into a mold, the metal material is first created in a powdered form. The powdered metal is then placed inside a metallic jacket. The metallic jacket is then subjected to a consolidation process to convert the powdered material into a solid metal part. The consolidation process can include hot isostatic pressing, where heat and pressure are applied to the outside of the metallic jacket so that the powdered metal material inside the jacket is fused into a solid metal unitary part. The consolidation process could also include extrusion or other consolidation methods.

When a process as described above is conducted to form a metal part, the grain size of the metal material is smaller than the grain size which results from melting the metal and pouring it into a mold. And because the grain size is smaller, it is possible to use an ultrasonic sensor to test the metal material for extremely small voids or imperfections in the material.

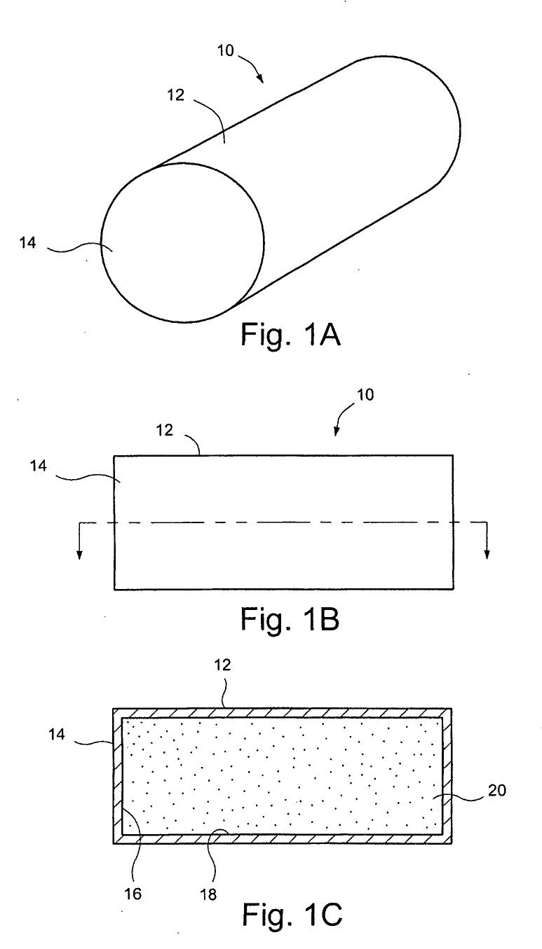

FIGS. 1A and 1B show a cylindrical metal jacket which could be used in a process of forming a cylindrical metal part. FIG. 1C is a sectional view of the cylindrical metal jacket 10 filled with a powdered material 20. The cylindrical metal jacket 10 includes a generally cylindrical sidewall 12 and end walls 14. The powdered metal material 20 is filled inside the inner side wall 18 and inner end wall 16 of the metal jacket 10.

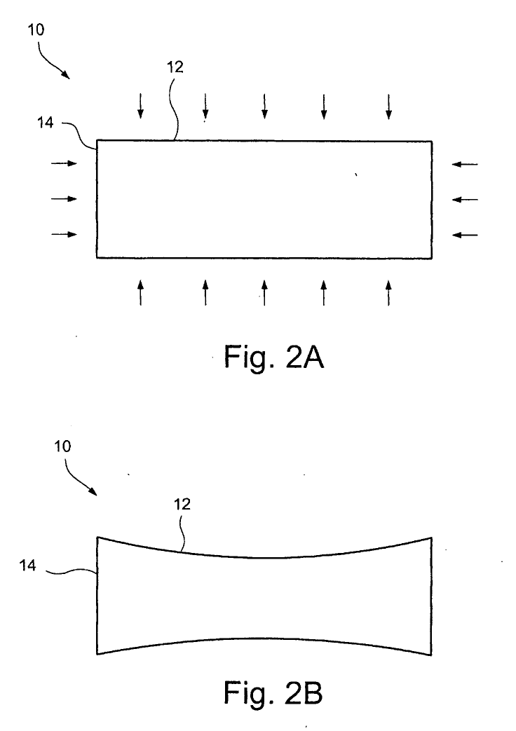

As shown in FIG. 2A, heat and pressure is then applied to the exterior surfaces of the cylindrical metal jacket 10. The heat and pressure cause the powdered metal material to fuse into a solid unitary metal part. However, the application of the pressure to the exterior sides of the cylindrical jacket 10 often result in the jacket being slightly deformed. As shown in FIG. 2B, after the application of heat and pressure, the diameter at the center of the cylindrical jacket 10 may be smaller than the diameter at the ends 14 of the jacket. The resulting hourglass shape is not ideal because the unitary metal part inside the jacket will also have the hourglass shape, and one would prefer to produce a unitary metal part which is substantially cylindrical with straight sidewalls.

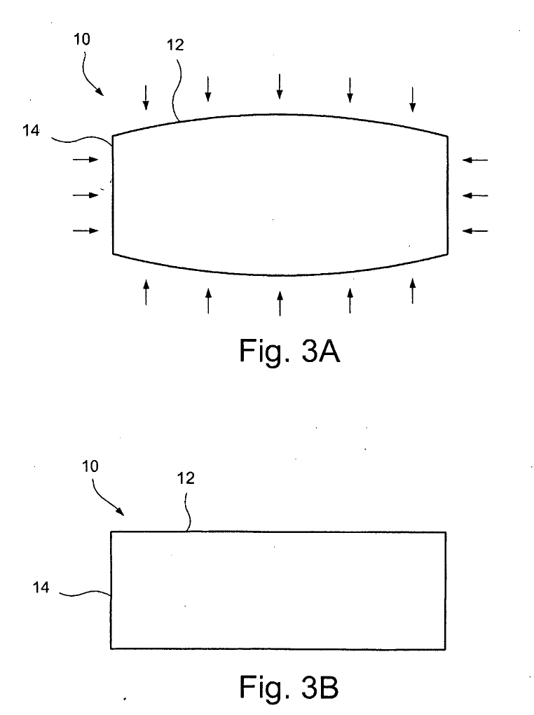

One way to perform a method of forming a metal part using this powdered metal process is to start with a jacket which is not perfectly cylindrical. As shown in FIG. 3A, if one starts with a metal jacket which has bulging sidewalls, where the diameter at the center of the cylindrical metal jacket is greater than the diameter at the end walls of the metal jacket, it may be possible to produce a metal part which is substantially cylindrical in shape. One assumes that the application of heat and pressure, as shown in FIG. 3A, will cause the center portions of the metallic jacket and the unitary metal part to become smaller. As a result, after the application of heat and pressure, as shown in FIG. 3B, the cylindrical metal jacket 10 and the underlying metal part would be substantially cylindrical with straight sidewalls.

After the metal part has been formed, it is necessary to inspect the part for voids or imperfections in the material. Ultrasonic sensors are typically used to perform these type of inspections. Because the part has been formed by applying heat and pressure to a metal jacket holding the powdered metal material, the grain size of the resulting part is sufficiently small that an ultrasonic sensor can be used to detect voids or imperfections having dimensions of 0.015 inches or less.

In some instances, it may be necessary to polish the exterior surface of the metallic jacket before the ultrasonic testing is performed. This provides a surface which facilitates the ultrasonic testing process.

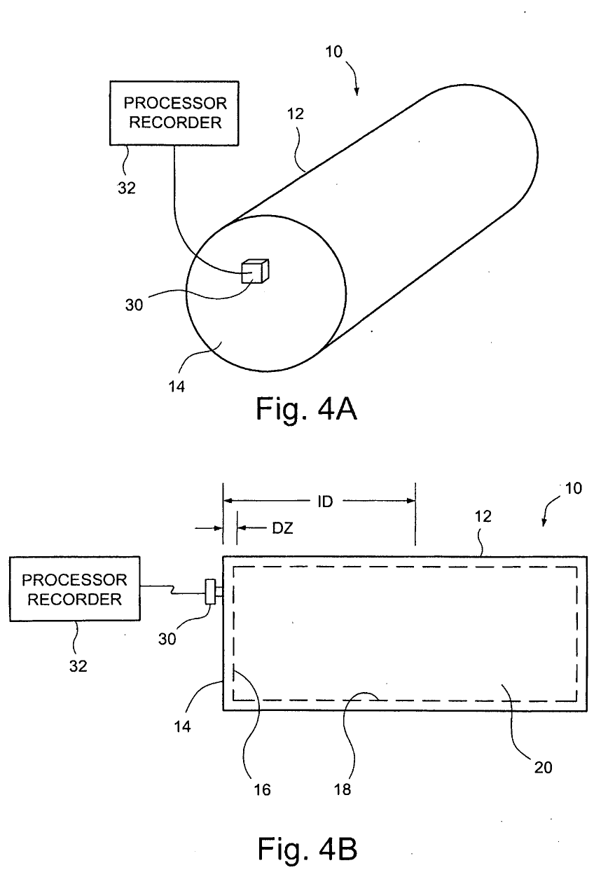

FIGS. 4A and 4B show a cylindrical metal part which is being subjected to testing by an ultrasonic inspection device. The ultrasonic inspection device includes an ultrasonic sensor 30 and a processor and recorder unit 32.

In some forms of testing, the ultrasonic sensor is brought adjacent an exterior surface of the metallic material, and the ultrasonic sensor is controlled by the recorder and processor unit 32 to detect the characteristics of the metal underlying the sensor. The sensor can be used to detect the characteristics of the metal at varying depths within the metal part.

In some forms of testing, the metal part is immersed in a liquid during the ultrasonic testing. In this type of testing, the ultrasonic sensor 30 will not need to directly contact the surface of the metal part 12. Instead, the sensor can be held a fixed distance away from the metal part. And this means that it is not necessary for the exterior surface of the metal part to be completely flat. The immersion ultrasonic testing techniques allow for testing of a part having curved or angled exterior surfaces.

FIG. 4B illustrates that there is typically a dead zone DZ located at the surface of the metallic part. The dead zone represents an area where the ultrasonic sensor 30 cannot accurately detect the characteristics of the metallic material. In other words, the sensor can only detect the characteristics of material accurately at a depth greater than the dead zone in the material. Also, as noted above, it is possible to inspect the characteristics of the material up to a maximum interrogation depth ID which can extend as much as 20 inches or more into the material.

In background art methods of producing and testing metal parts, the fact that the ultrasonic sensor could not detect the characteristics of the material in the dead zone meant that after an inspection or testing process had been performed, the material located in the dead zone must be removed. The material in the dead zone is removed because testing cannot determine whether there are imperfections or voids in that portion of the material. The removal of all material which was in the dead zone during the inspection process results in a waste of the material originally used to construct the metal part.

When a metal part is formed using the process described above, wherein a powdered metal material is placed in the metallic jacket, and the metallic jacket is subjected to heat and pressure, it may be possible to reduce the amount of material which must be removed from the metallic part due to the existence of the dead zone. When a process as outlined above is performed, after the heat and pressure has been applied to the metallic jacket to cause the powdered material to form a unitary metal object, the metallic jacket is still attached to the exterior of the unitary metallic part. One could then conduct ultrasonic testing on the metallic part while it is still located inside the metallic jacket. The metallic jacket would occupy some or all of the dead zone of the ultrasonic sensor. As a result, all or a majority of the material of the material of the metallic part inside the jacket could be tested with the ultrasonic sensor.

If the metallic jacket occupies all of the dead zone of the ultrasonic sensor, all of the material of the unitary metal part can be inspected with the ultrasonic sensor. This means that once the metallic jacket has been removed from the unitary metal part, it is not necessary to remove any of the metal of the metal part due to the existence of the dead zone of the ultrasonic sensor.

Alternatively, in some instances, the metallic jacket may occupy only a portion of the dead zone of the ultrasonic sensor. This would mean that the metal of the underlying metal part would also occupy a portion of the dead zone. In these instances, after the inspection has been conducted, and the metal jacket has been removed, it would also be necessary to remove a small portion of the surface of the metal object. However, even in this instance, because the metallic jacket was present during the ultrasonic testing, a smaller amount of the unitary metal part would have to be removed.

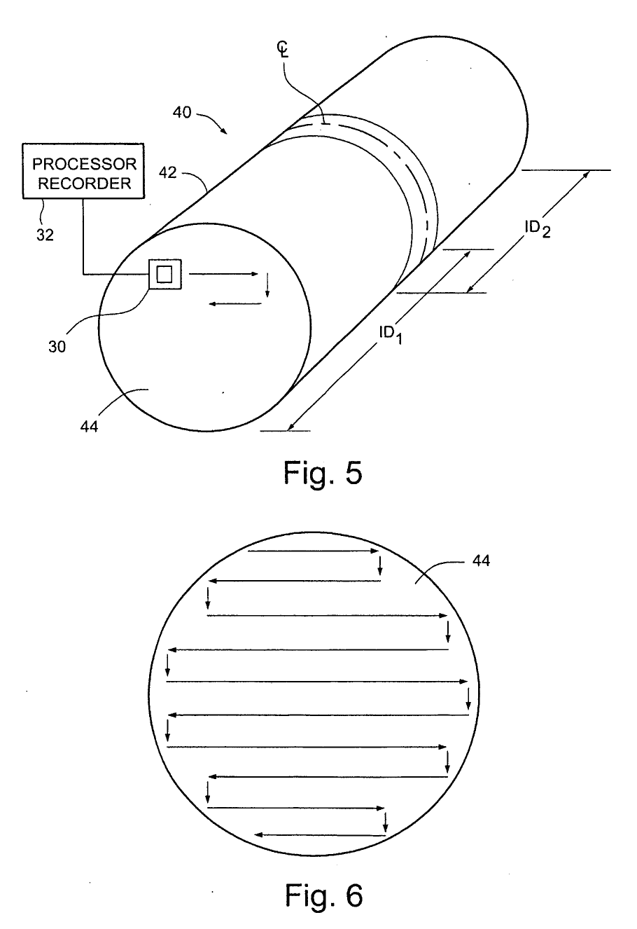

FIGS. 5 and 6 illustrate how an ultrasonic testing of the cylindrical metal part could be conducted. As shown in FIG. 5, in a contact method, the ultrasonic sensor 30 would be brought into contact with an end wall of the cylindrical metal part 40. Alternatively, in an immersion method, the ultrasonic sensor 30 would be positioned adjacent the end wall. The processor and recording device 32 would then be used to interrogate the metal material underlying the ultrasonic sensor 30. As explained above, the ultrasonic sensor can be controlled by the processor and recording device 32 to interrogate the metal at different depths under the ultrasonic sensor 30. Ideally, the processor and recorder 32 would be used to interrogate the characteristics of the metal material to an interrogation depth ID 1 which is located more than halfway down the length of the cylindrical metal object 40. Note, in FIG. 5 the interrogation depth ID 1 extends beyond the center line of the cylindrical metal part 40.

The ultrasonic sensor 30 would be moved to different portions of the end face 44 of the cylindrical metal part 40 to interrogate different portions of the metallic material underlying the end face 44 and the sensor 30. In some instances, it would be appropriate to move the sensor 30 according to the pattern of the arrows shown in FIG. 6. This would move the sensor 30 across all portions of the end face 44 of the metal part 40.

The ultrasonic sensor 30 would then be moved to the opposite end face of the cylindrical metal part 40 and the same process would be conducted to interrogate the metallic material at the other end of the metallic part. During the inspection process conducted on the opposite end of the metallic part, the ultrasonic sensor would check the characteristics of the underlying material to a second interrogation depth ID 2. As shown in FIG. 5, the interrogation depth during the first process conducted on the first end of the part would overlap with the interrogation depth during the second inspection step conducted on the opposite end of the metallic part. Because the inspection depths would overlap, this would ensure that all material inside the metallic part has been inspected.

As mentioned above, once the cylindrical metal part has been inspected it is also common to conduct forging operations to form a part having dimensions which are closer to the desired final form. After the forging operations are performed, the forged part is again subjected to ultrasonic testing to ensure that the forging operation did not introduce any new imperfections.

The prior art methods for testing the forged part used the contact method, where it was necessary for the ultrasonic sensor to be brought into contact with flat exterior surfaces of the part in order to conduct the testing. This meant that the forging operations had to be conducted to produce a generally rectilinear shaped forged part. Testing would then be conducted on the flat exterior surfaces of a rectilinear shaped forged part.

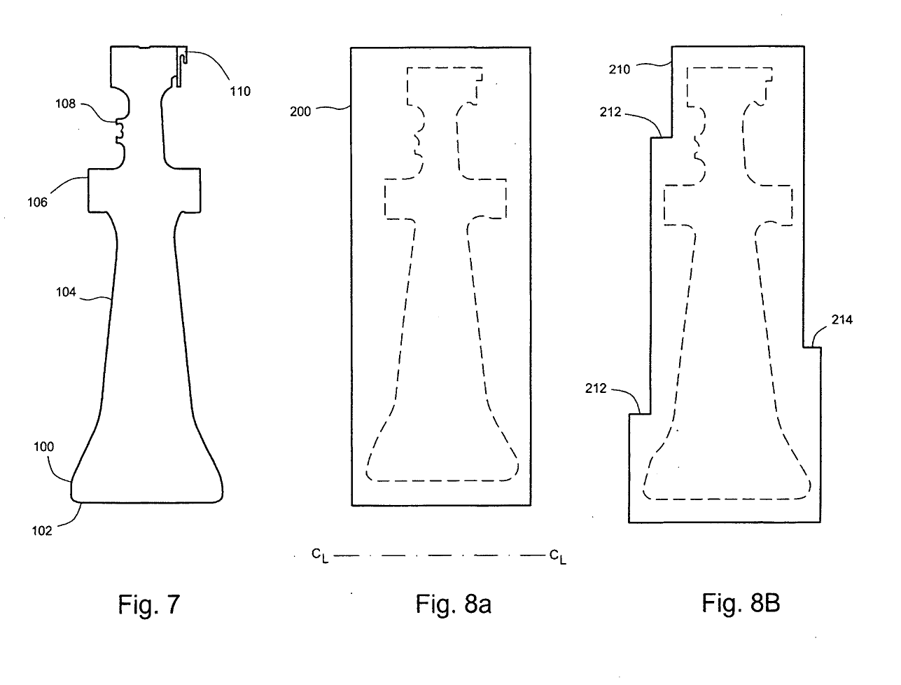

FIG. 7 illustrates the desired final form for an example metal part 100. The metal part 100 includes a wide base 102, a tapered portion 104, a shoulder 106, and two detailed shaped areas 108 and 110.

In the prior art methods, when it was necessary to convert a cylindrical part 200, as shown in FIG. 8A, into the final form shown in FIG. 7, the cylindrical part 200 would first be subjected to forging operations to create the forged metal part 210 shown in FIG. 8B. In FIGS. 8A and 8B, a dashed line shows the desired final form for the metal part 100, as shown in FIG. 7. The shape of the forged metal part 110 would have some steps 212 and 214 that cause the exterior shape of the forged metal part 210 to better approximate the final form of the desired metal part 100.

The steps 212 and 214 ensure that the forged metal part 210 is rectilinear so that an ultrasonic inspection using the contact technique can be performed after the forging operations have been performed. However, it may be necessary to lightly machine or polish the exterior surfaces of the forged metal part 210 after the forging operations have been performed, and before the ultrasonic testing is performed. Note, the forging operations do not result in the removal of any metal. Thus, the forging operations do not result in any waste of the material used to form the part.

Assuming the second ultrasonic inspection performed on the forged metal part 210 shown in FIG. 8B does not detect any imperfections in the forged metal part 210, machining operations would then be performed to convert the forged part 210 into the final desired metal part 100, as shown in FIG. 7. The machining operations would remove all of the metal of the forged metal part 210 outside of the dashed line appearing in FIG. 8B. And all of that metal would essentially be wasted. Thus, the final machining operations would remove a significant portion of the metal used to form the original cylindrical part 200.

As noted above, when immersion ultrasonic testing is performed, it is not necessary to bring the ultrasonic transducer into direct contact with a flat exterior surface of the metal part. Instead, the part is immersed in a liquid, and the ultrasonic transducer is held some distance away from the exterior surface of the part during the testing.

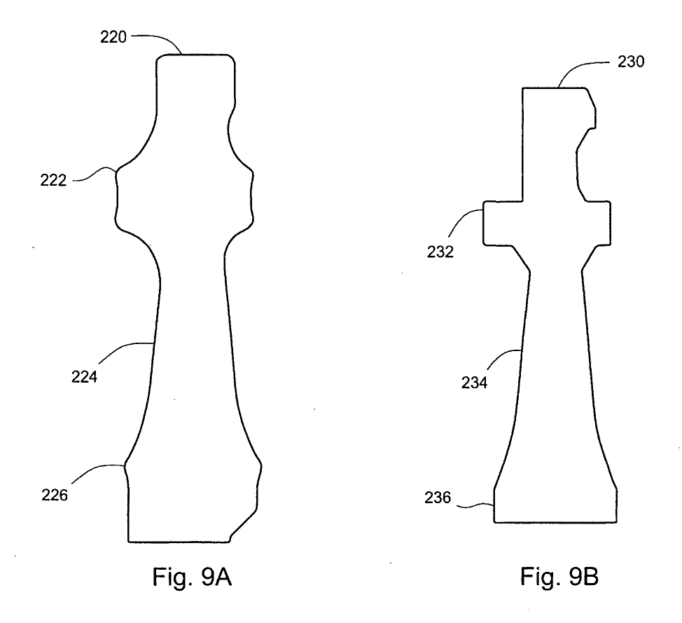

Because there is no requirement to contact a flat exterior surface of a part to conduct immersion ultrasonic testing, when immersion ultrasonic testing is performed the shape of the forged part does not need to be rectilinear. Thus, in methods embodying the invention, different forging techniques can be used to shape the original metal cylinder into a forged metal part having a shape that more closely resembles the desired final form shown in FIG. 7. Using these different forging techniques, it is possible to start with a cylinder of metal as shown in FIG. 8A, and then create a forged metal part 220, as shown in FIG. 9A. The forged metal part 220 includes a shoulder 222, a tapered portion 224 and a base portion 226.

The forged metal part shown in FIG. 9A is then subjected to some machining operations to smooth the exterior surface of the part, and to bring the shape of the part even closer to the desired final form. The result is a metal part 230, as shown in FIG. 9B. This metal part 230 has a shoulder 232, a tapered portion 234 and a base portion 236 that are even closer to the desired final form.

Immersion ultrasonic testing is then performed on the metal part shown in FIG. 9B. Because the immersion ultrasonic testing technique does not require the ultrasonic transducer to be brought into direct contact with a flat surface of the part, it is acceptable for the part being tested to include angled and curved surfaces, as shown in FIG. 9B.

Assuming the second ultrasonic testing of the part shown in FIG. 9B does not reveal any flaws, the part shown in FIG. 9B will then be subjected to additional machining operations to create the final desired shape, as shown in FIG. 7.

The forging operations used to arrive at the forged part shown in FIG. 9A do not remove any of the metal of the original cylindrical part. And because the forged part is very close to the final form, it is possible to start with a cylinder that is smaller than the starting cylinder used in the prior art techniques where the forging operations produced the rectilinear shaped part shown in FIG. 7B. Looked at another way, because the forging will create a shape close to the final form, less material must be removed during the subsequent machining steps as compared to the prior art methods. And if less material is removed during the machining steps, one can start with less material to begin with.

The fact that it is possible to start with a smaller cylindrical metal part means there are cost and material savings in producing the cylindrical part. In addition, because the cylindrical part that is subjected to the initial ultrasonic testing step is smaller, it requires less time to perform the initial inspection. Further, because the forging operations produce a shape that is close to the final form, fewer machining operations must be performed, which translates into additional time and cost savings. All of these factors together significantly reduce the cost of producing the part, as well as the time required to produce the part.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of forming and inspecting a metal part, comprising:
selecting a metallic jacket having sidewalls;
filling the metallic jacket with a powdered metal material;
applying heat and pressure to walls of the metallic jacket to cause the powdered metal material to form a unitary metal part; and
inspecting the unitary metal part with an ultrasonic sensor through the walls of the metallic jacket.

2. The method of claim 1, wherein the ultrasonic sensor has a dead zone immediately adjacent the sensor where the sensor cannot accurately inspect an underlying material, and wherein during the inspecting step, the metallic jacket is located in the dead zone.

3. The method of claim 2, wherein the selecting step comprises selecting a metallic jacket having sidewalls with a thickness that is greater than a depth of the dead zone of the ultrasonic sensor such that during the inspecting step, the metallic jacket occupies all of the dead zone of the ultrasonic sensor.

4. The method of claim 2, wherein during the step of applying heat and pressure to the metal jacket, a thickness of portions of the metal jacket are altered, and wherein the selecting step comprises selecting a metallic jacket having a thickness such that after the application of the heat and pressure, the portions of the metallic jacket that are located under the ultrasonic sensor during the inspection step have a thickness which occupies all of the dead zone of the ultrasonic sensor.

5. The method of claim 1, wherein the ultrasonic sensor has a dead zone immediately adjacent the sensor where the sensor cannot accurately inspect an underlying material, wherein during the inspecting step, the metallic jacket is located in only a portion of the dead zone, and wherein the method further comprises removing any metal from the unitary part that was located in the dead zone during the inspection step.

6. The method of claim 1, wherein the selecting step comprises selecting a metallic jacket that is generally cylindrical, with sidewalls that bulge outward towards a center of the cylindrical metallic jacket.

7. The method of claim 6, wherein during the step of applying heat and pressure to the generally cylindrical metallic jacket, a diameter of the center portion of the generally cylindrical metallic jacket is made smaller.

8. The method of claim 7, wherein the selecting step comprises selecting a generally cylindrical metallic jacket that is shaped such that after the step of applying heat and pressure to the metallic jacket is performed, the metallic jacket is substantially cylindrical with substantially straight sides.

9. The method of claim 7, wherein the selecting step comprises selecting a generally cylindrical metallic jacket that is shaped such that after the step of applying heat and pressure to the metallic jacket is performed, the unitary metal part inside the metallic jacket is substantially cylindrical with substantially straight sides.

10. A method of forming and inspecting a metal part, comprising:
selecting a substantially cylindrical metallic jacket having sidewalls and first and second ends;
filling the metallic jacket with a powdered metal material;
applying heat and pressure to the metallic jacket to cause the powdered metal material to form a generally cylindrical unitary metal part;
inspecting the unitary metal part with an ultrasonic sensor to determine whether there are voids or imperfections in the material of the unitary metal part;
forging the unitary metal part to form a forged metal part having angled or curved exterior surfaces; and
inspecting the forged metal part using an immersion ultrasonic testing technique.

11. The method of claim 10, further comprising machining an exterior surface of the forged metal part to produce an inspectable forged metal part before performing the second inspecting step.

12. The method of claim 11, further comprising machining the inspectable forged metal part after the second inspecting step has been performed to produce the final shape of the metal part.

13. The method of claim 10, wherein the first inspecting step comprises:
conducting a first inspection step by moving the ultrasonic sensor across different portions of a first end face of the unitary metal part to inspect material of the unitary metal part to an inspection depth that is greater than half a height of the cylindrical unitary metal part; and
conducting a second inspection step by moving the ultrasonic sensor across different portions of a second end face of the unitary metal part to inspect material of the unitary metal part to an inspection depth that is greater than half of the height of the cylindrical unitary metal part, wherein during the first and second inspection steps, the inspection depths overlap at a central portion of the cylindrical unitary metal part.

14. The method of claim 10, wherein the first inspecting step comprises immersion ultrasonic testing.

15. The method of claim 14, wherein the immersion ultrasonic testing is conducted while the unitary metal part is still inside the metallic jacket.

16. A method of forming and inspecting a metal part, comprising:
forming a generally cylindrical metal part;
inspecting the cylindrical metal part via immersion ultrasonic testing to determine whether there are voids or imperfections in the material of the cylindrical metal part;
forging the cylindrical metal part to form a forged metal part having angled or curved exterior surfaces;
machining the forged metal part to remove portions of the metal of the forged metal part to produce an inspectable metal part; and
inspecting the inspectable metal part via immersion ultrasonic testing to determine whether there are voids or imperfections in the material of the inspectable metal part.

17. The method of claim 16, further comprising machining the inspectable forged metal part after the second inspecting step has been performed to produce the final shape of the metal part.

18. The method of claim 16, wherein the first and second inspecting steps determine whether there are voids or imperfections in the material of the metal part having a dimension as small as approximately 0.015 inches.
